(19) United States
(12) Patent Application Publication
(10) Pub. No.: US 2025/0014167 A1
(43) Pub. Date: Jan. 9, 2025

(54) MEMORY-BASED VISION INSPECTION DEVICE FOR MAINTAINING INSPECTION PERFORMANCE, AND METHOD THEREFOR

(71) Applicant: LG MANAGEMENT DEVELOPMENT INSTITUTE CO., LTD., Seoul (KR)

(72) Inventors: Jeeho HYUN, Seoul (KR); Dongsub Shim, Seoul (KR); Jongseong Jang, Seoul (KR); Sangyun Kim, Seoul (KR); Byungjun Kang, Yongin-si (KR); Youngsan Koh, Seoul (KR); Seunghwan Kim, Seoul (KR)

(21) Appl. No.: 18/892,502

(22) Filed: Sep. 22, 2024

Related U.S. Application Data
(63) Continuation of application No. PCT/KR2023/003767, filed on Mar. 22, 2023.

(30) Foreign Application Priority Data
Mar. 23, 2022 (KR) 10-2022-0036157

(51) Int. Cl. G06T 7/00; G06T 7/11; G06V 10/764

(52) U.S. Cl. CPC G06T 7/0008; G06T 7/11; G06V 10/764; G06T 2207/20081

(57) ABSTRACT

A vision inspection device includes: a memory including a buffer; and a processor configured to: acquire a plurality of divided images by dividing a captured product image into a plurality of pieces and a new data set including new normal product type data and new defective type data corresponding to the plurality of divided images; sample at least one buffer data set among a plurality of buffer data sets stored in the buffer; generate a mini batch by combining the sampled buffer data set with the new data set; and determine whether to store the new data set in the buffer by using a soft nearest neighbor loss (SNNL) value of the new data set constituting the mini batch, and a cumulative average SNNL value of each of the buffer data sets constituting the mini batch.

### CROSS REFERENCE TO RELATED APPLICATIONS

This application is a Bypass Continuation of International Patent Application No. PCT/KR2023/003767, filed on Mar. 22, 2023, which claims priority from and the benefit of Korean Patent Application No. 10-2022-0036157, filed on Mar. 23, 2022, each of which is hereby incorporated by reference for all purposes as if fully set forth herein.

### BACKGROUND

### Field

Embodiments of the invention relate generally to a vision inspection device for vision inspection, and more specifically, to a memory-based vison inspection device for maintaining inspection performance, and method therefor.

### Discussion of Background

Vision inspection detects defects that are visible in the appearance of products. The performance of vision inspections has improved dramatically through a deep learning classification model that distinguishes normal products from defective products.

In order to train a deep learning classification model, extensive data is required. However, as the production process lines are designed to mass-produce normal products, only a limited amount of defective data is typically available, making it challenging to collect sufficient defective data for training over time.

In addition, there may be types of defects that do not occur during the data collection period. Once trained, when a new type of data is input to a model, such would be classified based on the previously learned criteria, potentially misclassifying the new types of defective products as normal products.

Additionally, according to conventional methods, training an existing model with new data may lead to catastrophic forgetting, and losing information about previous data. This can result in incorrect classification for types in earlier training data but absent in new data, similar to that described above.

To address these issues, conducting learning process using both old and new data significantly increases the data amount, thereby considerably extending the learning time.

Since vision inspection needs to detect even minor defects, high-resolution images of the product are divided into segments for inspection. However, due to various external factors such as differences in production lines and variations in data due to the surrounding environment such as light sources, subtle changes in the dataset can occur compared to when the initial vision inspection deep learning classification model is constructed. In addition, as the process continues, the performance of the inspection device may degrade over time due to factors such as changes in defect types or the introduction of new defects.

The above information disclosed in this Background section is only for understanding of the background of the inventive concepts, and therefore, it may contain information that does that constitute prior art.

### SUMMARY

Memory-based vison inspection devices for maintaining inspection performance, and method therefor according to embodiments of the invention are capable of improving the performance of a product classification model that distinguishes normal products from defective products.

Further, memory-based vison inspection devices for maintaining inspection performance, and method therefor according to embodiments of the invention are capable of improving the classification performance of a product classification model by sampling new data and buffer data previously stored in a buffer.

According to various embodiments of the invention, a portion of previous data including key information required for learning is stored in the buffer, and when learning a product classification model using new data, previous data is also utilized to thereby improve the learning speed and enhance classification performance from utilizing both old and new data.

Additional features of the inventive concepts will be set forth in the description which follows, and in part will be apparent from the description, or may be learned by practice of the inventive concepts.

According to one or more embodiments of the invention, a vision inspection device includes: a memory including a buffer; and a processor configured to: acquire a plurality of divided images by dividing a captured product image into a plurality of pieces and a new data set including new normal product type data and new defective type data corresponding to the plurality of divided images; sample at least one buffer data set among a plurality of buffer data sets stored in the buffer; generate a mini batch by combining the sampled buffer data set with the new data set; and determine whether to store the new data set in the buffer by using a soft nearest neighbor loss (SNNL) value of the new data set constituting the mini batch, and a cumulative average SNNL value of each of the buffer data sets constituting the mini batch.

When there is a single buffer data with a cumulative average SNNL value greater than the SNNL value of the new data set, the processor may be configured to replace the corresponding buffer data set with the new data set and store the replaced new data set in the buffer.

When there is a plurality of buffer data with a cumulative average SNNL value greater than the SNNL value of the new data set, the processor may be configured to exchange the buffer data with the largest SNNL value with new data set and store the exchanged new data in the buffer.

When there is a plurality of buffer data with a cumulative average SNNL value greater than the SNNL value of the new data set, the processor may be configured to exchange one of the buffer data with new data set through random sampling and store the exchanged new data in the buffer.

When there is no buffer data set with a cumulative average SNNL value greater than the SNNL value of the new data set, the processor may be configured to delete the new data set.

The processor may be configured to calculate the SNNL value according to Equation 1 below.

$${l}_{sn} ( x , y , T ) = - \frac{1}{b} {\sum }_{i ∈ 1 … b} log ( \frac{{{{\sum }_{j ∈ 1 … b}}_{j \neq i}}_{{y}_{i} = {y}_{j}} {e}^{- \frac{{‖ {x}_{i} - {x}_{j} ‖}^{2}}{T}}}{{{{\sum }_{k ∈ 1 … b}}_{k \neq i}}^{e - \frac{{‖ {x}_{i} - {x}_{k} ‖}^{2}}{T}}} ) \qquad [ Equation 1 ]$$

(x is the representation vector of the input data, y is the class information, b is the batch, and T is the temperature, which is a hyperparameter).

When the new data set has a first label that matches the largest number of buffer data sets in the buffer, the processor may be configured to generate the mini batch by sampling the buffer data set with the first label.

When the new data set has a second label that has previously matched the largest number of buffer data sets, the processor may be configured to generate the minibatch by sampling the buffer data set with the second label.

When the new data set does not have a first label that currently matches the largest number of buffer data set and does not have a second label that previously matches the largest number of buffer data set, the processor may be configured to generate the mini batch by sampling the buffer data set with the first label.

When the new data set does not have a first label that currently matches the largest number of buffer data set and does not have a second label that previously matches the largest number of buffer data set, the processor may be configured to: i) acquire a third label that currently matches the largest number of buffer data sets in the buffer, ii) sample the buffer data set that matches the third label, and iii) generate the mini batch.

The vision inspection device may further include: a learning processor configured to train one or more product classification models to determine whether a product is normal from the product image using updated data stored in the buffer.

The processor may be further configured to: a) share one memory buffer to train a plurality of product classification models through the learning processor, b) acquire determination result values for each of the plurality of product classification models from the input product image, and c) calculate the average of the determination result values and output the final determination result of the product whether the product is normal product or defective product.

The processor may be configured to sample at least one buffer data set among the plurality of buffer data sets stored in the buffer based on a weight according to a preset reference.

According to another embodiment of the invention, a method for operating a vision inspection device including a buffer, the method includes the steps of: acquiring, by a processor, a plurality of divided images by dividing a captured product image into a plurality of pieces and acquiring a new data set including new normal product type data and new defective type data corresponding to the plurality of divided images; sampling, by the processor, at least one buffer data set among a plurality of buffer data sets stored in the buffer; generating, a mini batch by combining the sampled buffer data set with the new data set; and determining, by the processor, whether to store the new data set in the buffer by using a soft nearest neighbor loss (SNNL) value of the new data set constituting the mini batch, and a cumulative average SNNL value of each of the buffer data sets constituting the mini batch.

The step of sampling at least one buffer data set may include the step of: sampling at least one buffer data set among the plurality of buffer data sets stored in the buffer based on a weight according to a preset reference.

The method may further include the steps of: when there is a single buffer data with a cumulative average SNNL value greater than the SNNL value of the new data set, replacing, by the processor, the corresponding buffer data set with new data set, and storing, by the processor, the replaced new data in the buffer.

The method may further include the step of: when there is no buffer data with a cumulative average SNNL value greater than the SNNL value of the new data set, deleting, by the processor, the new data set.

The method may further include the step of: training, by a learning processor, one or more product classification models to determine whether a product is normal from the product image using updated data stored in the buffer.

The method may further include the steps of: sharing, by the processor, one memory buffer to train a plurality of product classification models through the learning processor, acquiring, by the processor, determination result values for each of the plurality of product classification models from the input product image, and calculating, by the processor, the average of the determination result values and output the final determination result of the product whether the product is normal product or defective product.

According to still another embodiment of the invention, a recording medium storing a computer-readable program for executing a method for operating a vision inspection device, wherein the method includes the steps of: acquiring a plurality of divided images by dividing a captured product image into a plurality of pieces and acquiring a new data set including new normal product type data and new defective type data corresponding to the plurality of divided images; sampling at least one buffer data set among a plurality of buffer data sets stored in the buffer based on a weight according to a preset reference; generating a mini batch by combining the sampled buffer data set with the new data set; and determining whether to store the new data set in the buffer by using a soft nearest neighbor loss (SNNL) value of the new data set constituting the mini batch, and a cumulative average SNNL value of each of the buffer data sets constituting the mini batch.

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a block diagram of an artificial intelligence device according to an embodiment of the invention.

FIG. 2 is a block diagram of an artificial intelligence server according to an embodiment of the invention.

FIG. 3 is a flowchart illustrating a method for operating an artificial intelligence device according to an embodiment of the invention.

FIG. 4 is a diagram showing a process of acquiring a data set for learning according to an embodiment of the invention.

FIG. 5 is a diagram illustrating a process of generating a mini batch according to an embodiment of the invention.

FIG. 6 is a diagram illustrating an example of a data augmentation method according to an embodiment of the invention.

FIG. 7 is a diagram illustrating a method for operating an artificial intelligence device according to another embodiment of the invention.

FIG. 8 is a diagram structuring an embodiment in FIG. 7.

FIG. 9 is a diagram illustrating a process of updating a memory buffer based on representation vectors of each of a plurality of product classification models according to an embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, embodiments of the invention are described in more detail with reference to accompanying drawings and regardless of the drawing's symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In addition, when it is determined that the detailed description of the related known technology may obscure the gist of embodiments disclosed herein in describing the embodiments, a detailed description thereof will be omitted. Additionally, the accompanying drawings are used to help easily understanding embodiments disclosed herein but the inventive concepts are not limited to such embodiments. It should be understood that all of variations, equivalents or substitutes contained in the inventive concepts are also included.

### <Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method for learning an artificial neural network in a state in which a label for learning data is given, and the label may mean the correct answer (or result value) that the artificial neural network must infer when the learning data is input to the artificial neural network. The unsupervised learning may refer to a method for learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

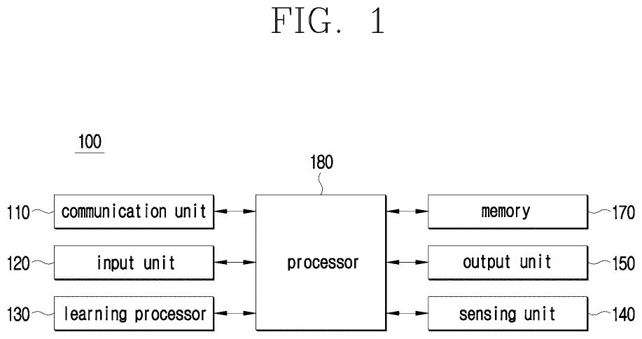

FIG. 1 is a block diagram of an artificial intelligence device according to an embodiment of invention.

An AI device 100 may be implemented by a stationary device or mobile device, such as a TV, a projector, a mobile phone, a smartphone, a desktop computer, a laptop computer, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, a processor 180, and the like.

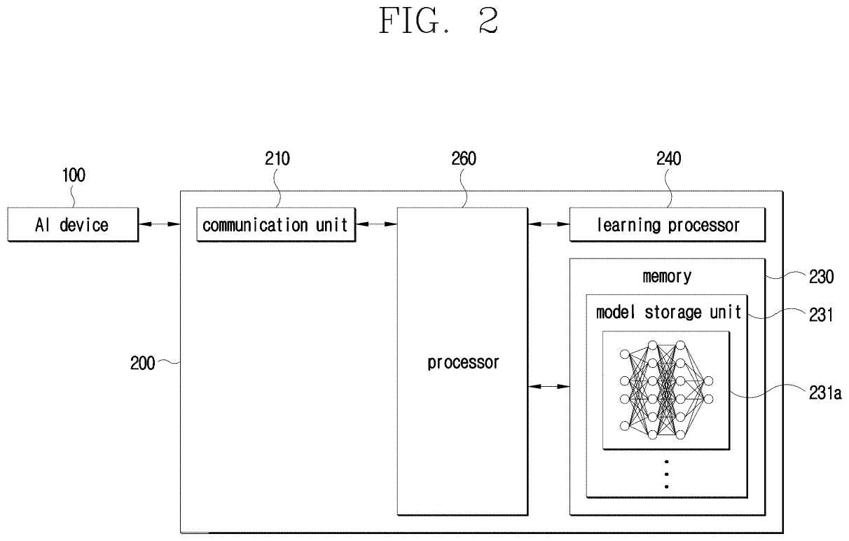

The communication unit 110 may transmit and receive data to and from external devices such as other AI devices and an AI server 200 shown in FIG. 2 by using wire/wireless communication technology. For example, the communication unit 110 may transmit and receive sensor information, a user input, a learning model, and a control signal to and from external devices.

The communication technology used by the communication unit 110 may include Global System for Mobile communication (GSM), Code Division Multi Access (CDMA), Long Term Evolution (LTE), 5G, WLAN (Wireless LAN), Wireless-Fidelity (Wi-Fi), Bluetooth™, Radio Frequency Identification (RFID), Infrared Data Association (IrDA), ZigBee, Near Field Communication (NFC), and the like.

The input unit 120 may acquire various kinds of data.

The input unit 120 may include a camera for inputting a video signal, a microphone for receiving an audio signal, a user input unit for receiving information from a user, and the like. In some embodiments, the camera or microphone may be treated as a sensor, and the signal acquired from the camera or microphone may be referred to as sensing data or sensor information.

The input unit 120 may acquire a learning data for model learning and an input data to be used when an output is acquired by using learning model. The input unit 120 may acquire raw input data. In this case, the processor 180 or learning processor 130 may extract an input feature by preprocessing the input data.

The learning processor 130 may train a model composed of an artificial neural network by using learning data. Here, the learned artificial neural network may be referred to as a learning model. The learning model may be used to an infer result value for new input data rather than learning data, and the inferred value may be used as a basis for determination to perform a certain operation.

The learning processor 130 may perform AI processing together with a learning processor 240 of the AI server 200.

The learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, without being limited thereto.

The output unit 150 may generate an output related to a visual sense, auditory sense, or haptic sense.

The output unit 150 may include a display unit for outputting visual information, a speaker for outputting auditory information, a haptic module for outputting haptic information, and the like.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or memory 170. The processor 180 may control the components of the AI device 100 to execute the predicted operation or the operation determined to be desirable among the at least one executable operation.

For example, when the connection of an external device is required to perform the determined operation, the processor 180 may generate a control signal for controlling the corresponding external device and may transmit the generated control signal to the external device.

The processor 180 may acquire intention information for the user input and may determine the user's requirements based on the acquired intention information.

More particularly, the processor 180 may classify the input image into the image intended for a specific application field by extracting the features of the image through an image classification engine including an image feature extraction network on an image by image basis.

At least one of the image classification engine including the image feature extraction network may be configured as an artificial neural network, at least part of which is trained according to a machine learning algorithm. In addition, at least one of the image classification engine including an image grouping engine or image feature extraction network may be trained by the learning processor 130, may be learned by the learning processor 240 of the AI server 200, or may be learned by their distributed processing.

The processor 180 may collect history information including the operation contents of the AI device 100, the user's feedback on the operation, and the like. The processor 180 may further store the collected history information in the memory 170 or learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 is a block diagram of an AI server according to an embodiment of the invention.

Referring to FIG. 2, the AI server 200 may refer to a device that trains an artificial neural network by using a machine learning algorithm or uses a trained artificial neural network. The AI server 200 may include a plurality of servers to perform distributed processing, or may be defined as a 5G network. In some embodiments, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 may transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may train the artificial neural network 231a by using the learning data. The learning model may be used in a state of being mounted on the AI server 200 of the artificial neural network, or may be used in a state of being mounted on an external device such as the AI device 100.

The learning model may be implemented as a hardware, software, or a combination of hardware and software. If all or part of the learning models are implemented as a software, one or more instructions that constitute the learning model may be stored in memory 230.

The processor 260 may infer the result value for new input data by using the learning model and may generate a response or control command based on the inferred result value.

A product classification model according to embodiments may be trained according to continual learning.

A continual learning may be a technique that improves model performance by continuously learning new data/tasks each time a model is trained.

Hereinafter, the artificial intelligence device may be referred to as a vision inspection device.

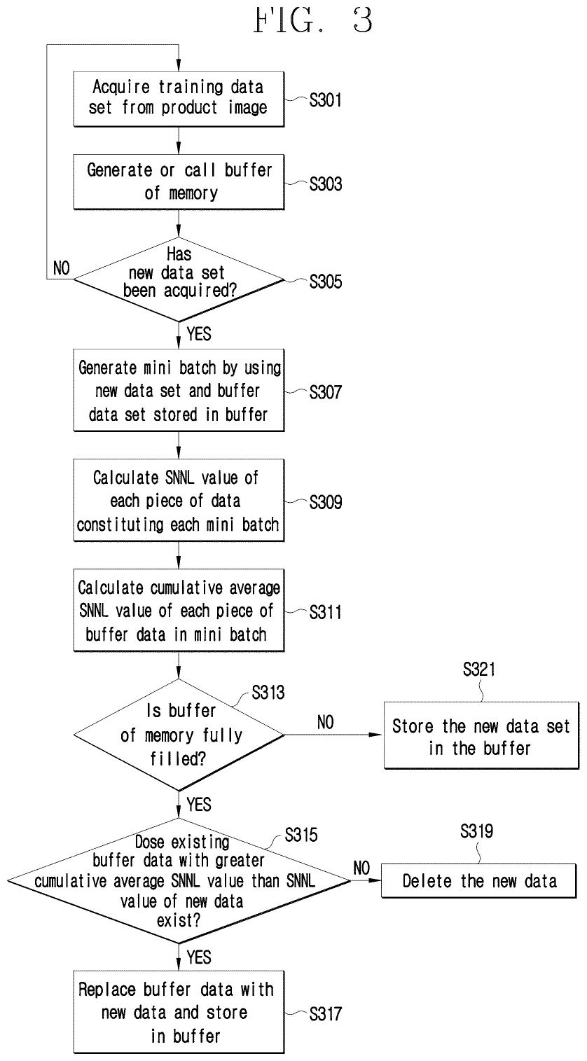

FIG. 3 is a flowchart illustrating a method for operating an artificial intelligence device according to an embodiment of the invention.

Referring to FIG. 3, the processor 180 of the artificial intelligence (AI) device 100 acquires a learning data set (or a training data set) from an image of a learning product (S301).

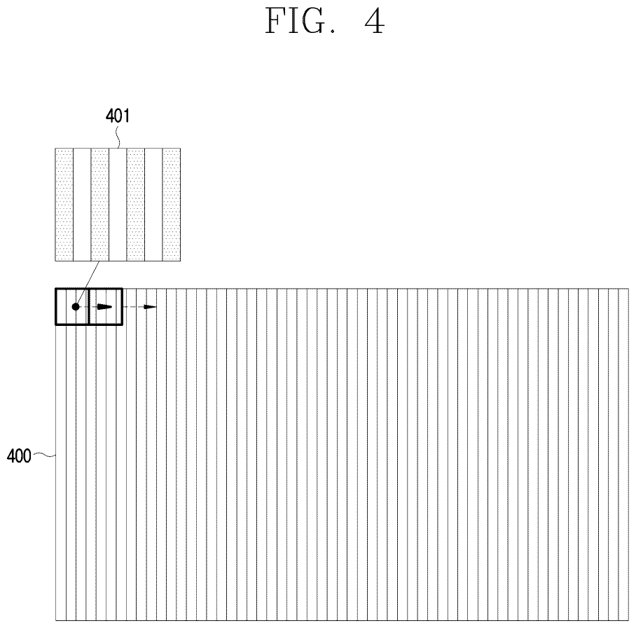

The learning data set may include divided images, acquired by dividing one product image into a plurality of pieces. The step of acquiring a learning data set and the additional steps of the method of operating the artificial intelligence device illustrated in FIG. 3 will be further described below with reference to FIGS. 4 to 6.

FIG. 4 is a diagram showing a process of acquiring a data set for learning according to an embodiment of the invention.

Referring to FIG. 4, a high resolution product image 400 is shown.

The input unit 120 of the artificial intelligence device 100 may be provided with a vision inspection camera (not shown) and may capture a product image 400 through the camera.

The processor 180 may acquire divided images by dividing the captured product image 400 into a plurality of pieces.

The processor 180 may acquire a divided image 401 by dividing or segmenting the product image 400 into box-shaped (or window) images of a preset shape.

The processor 180 may acquire a plurality of divided images as a learning data set.

Referring back to FIG. 3, the processor 180 of the artificial intelligence device 100 generates or calls a buffer in the memory 170 (S303).

The buffer of the memory 170 may be a temporary storage space. The buffer may occupy some of the total storage space of the memory 170.

If the buffer does not exist in the memory 170, the processor 180 may generate a new buffer with a certain storage space.

If a buffer exists in the memory 170, the processor 180 may call the corresponding buffer.

In order to train a product classification model that is capable of classifying a product as normal or defective from an image, physical storage space may be utilized to store data such as divided images, a normal product label indicating a normal product, and a defective product label indicating a defective product.

When storing data in a volatile memory such as RAM, increasing the buffer size generally requires an increase in RAM capacity due to physical limitations.

In an embodiment, storage space may be allocated to a non-volatile memory such as a disk having a size equal to the size of the initially set buffer. Additional data may be stored in the buffer.

When the maximum size of the buffer is determined, the processor 180 may proceed to train the product classification model through the learning processor 130. The processor 180 may variably store data up to the maximum size of the buffer.

The product classification model may be an artificial neural network-based model that determines whether a product is normal or defective from image data. The product classification model may be supervised-trained using a set of feature vectors extracted from image data and information labeled as normal product or defective products.

The processor 180 may train the product classification model by minimizing the loss of a loss function, which represents a difference between the classification type predicted by the product classification model and the correct label information of the corresponding learning data.

When large-scale learning is in progress, the processor 180 may store the images stored in the buffer, normal product labels, and defective product labels in a separate database. The processor 180 may read data stored in the database for learning.

The processor 180 of the artificial intelligence device 100 determines whether a new data set has been acquired (S305). If a new data set is acquired, the processor 180 generates a mini batch using a new data set and the buffer data set previously stored in the buffer of the memory 170 (S307).

The new data set may include new normal product type data and new defective type data. Each of the new normal product type data and the new defective type data may be formed in plural.

The new data set may be the set acquired in step S301.

The buffer data set is a set previously stored in the buffer and may include normal product type data and defective type data. The buffer may include a plurality of buffer data sets.

The processor 180 may generate a mini batch by concatenating the new data set and the buffer data set stored in the buffer.

The mini batch may be used for the learning of the product classification models.

Each mini batch may include new normal product type data, new defective (or defective product) type data, normal product type data stored in the buffer, and defective product type data stored in the buffer.

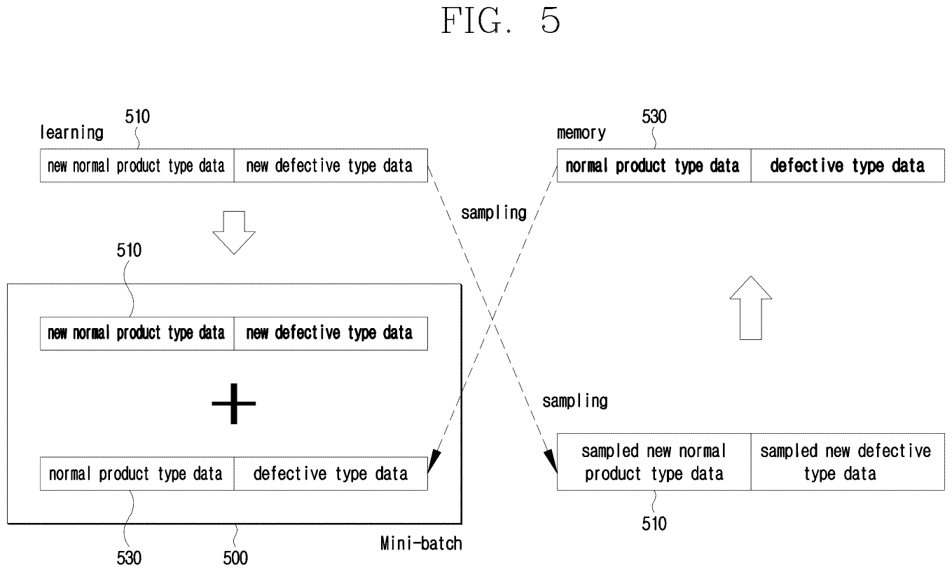

The mini batch will be described in further detail below with reference to FIG. 5.

FIG. 5 is a diagram illustrating a process of generating a mini batch according to an embodiment of the invention.

Referring to FIG. 5, the mini batch 500 may include a new data set 510 acquired in step S301 and a buffer data set 530 stored in the buffer of the memory 170.

The new data set 510 may include new normal product type data and new defective type data.

The buffer data set 530 may include normal product type data and defective type data.

In an embodiment, the same number of data for each label may be induced to be stored in the buffer. The label may be correct data corresponding to a specific normal product type or a specific defective product type.

To this end, candidate data for deletion may be selected from the buffer.

In an embodiment, the processor 180 may read one of the plurality of buffer data sets stored in the buffer based on the weight assigned to each label. A label with more buffer data may have a higher weight. A high weight may indicate a high probability of being sampled for mini batch 500.

In an embodiment, if new data has a label (e.g., a first label) that matches the largest number of buffer data in the current buffer of the memory, the processor 180 may sample the buffer data with the corresponding label (e.g., the first label). In other words, when the new data set has a first label that matches the largest number of buffer data sets in the buffer, the processor 180 may generate the mini batch 500 by sampling the buffer data set with the first label.

More particularly, in order to reduce the number of buffer data of the label that matches the largest number of buffer data, the buffer data of the corresponding label may be selected as an object of soft nearest neighbor loss (SNNL) comparison with new data.

In another embodiment, if certain new data does not have a label (e.g., the first label) matching the largest number of current buffer data but has a label (e.g., a second label) that has previously matched the largest number of buffer data, the processor 180 may sample the buffer data with the corresponding label (e.g., the second label). In other words, when the new data set has a second label that has previously matched the largest number of buffer data sets, the processor 180 may generate the minibatch 500 by sampling the buffer data set with the second label.

In still another embodiment, if certain new data has a label (e.g., a third label) that matches neither the largest number of current data nor the largest number of previous data, the processor 180 may sample buffer data that has a label (e.g., the first label) that matches the largest number of current data. In other words, when the new data set does not have a first label that currently matches the largest number of buffer data set and does not have a second label that previously matches the largest number of buffer data set, the processor 180 may generate the mini batch 500 by sampling the buffer data set with the first label.

The processor 180 may combine a new data set 510 and a buffer data set 530 to generate a mini batch 500.

The processor 180 may perform an augmentation operation on each data constituting the mini batch 500 to increase the learning data of the product classification model.

The processor 180 may process data using augmentation methods such as random horizontal/vertical flip, random rotation, and random shift for each data constituting the mini batch 500.

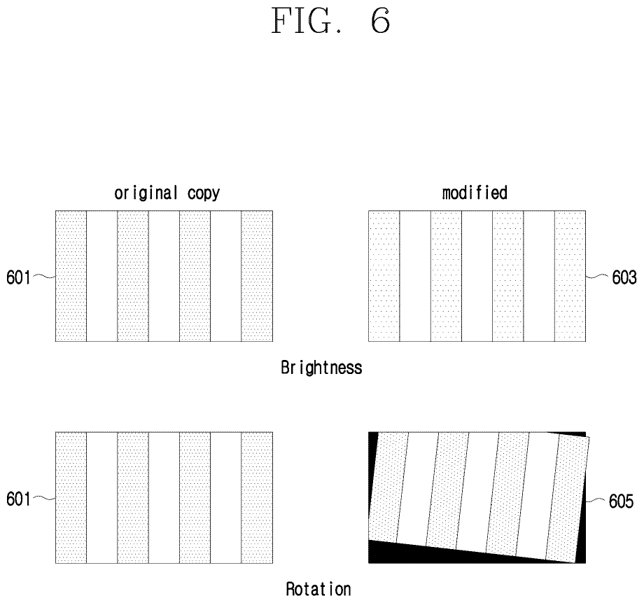

FIG. 6 is a diagram illustrating an example of a data augmentation method according to an embodiment of the invention.

Referring to FIG. 6, original image data (or original copy) 601 is shown. The original image data may be either normal product type data or defective type data.

When the brightness of the original image 601 is adjusted, first modified data 603 may be acquired.

When the rotation angle of the original image 601 is adjusted, second modified data 605 may be acquired.

In this manner, the processor 180 may secure the learning data used for training the product classification model through data augmentation.

Referring back to FIG. 3, the processor 180 of the artificial intelligence device 100 calculates a soft nearest neighbor loss (SNNL) value of each data constituting each mini batch (S309).

The processor 180 may calculate the SNNL value of each data using Equation 1 below.

$${l}_{sn} ( x , y , T ) = - \frac{1}{b} {\sum }_{i ∈ 1 … b} log ( \frac{{{{\sum }_{i ∈ 1 … b}}_{j \neq i}}_{{y}_{i} = {y}_{j}} {e}^{- \frac{{‖ {x}_{i} - {x}_{j} ‖}^{2}}{T}}}{{{{\sum }_{k ∈ 1 … b}}_{k \neq i}}^{e - \frac{{‖ {x}_{i} - {x}_{k} ‖}^{2}}{T}}} ) \qquad [ Equation 1 ]$$

Here, x denotes the representation vector (or feature vector) of the input data, y denotes the class (or type) information, b denotes the batch, and T denotes the temperature, which is a hyperparameter.

The class information may indicate whether the corresponding data belongs to one of a plurality of normal product types or a plurality of defective types.

The closer a distance between representation vectors of data within the same class compared to the representation vector distance of the entire data, the lower the SNNL value may be acquired.

The processor 180 of the artificial intelligence device 100 calculates the cumulative average SNNL value of each of the buffer data included in the mini batch (S311).

Each buffer data may be one of the buffer data (normal product type data or defective type data) included in the mini batch.

Each time a new data set is acquired, the processor 180 may calculate the SNNL of each buffer data included in the mini batch and calculate the average of the accumulated SNNL values of each buffer data.

The processor 180 calculates the SNNL value of the new data constituting the mini batch and the cumulative average SNNL value of each of the buffer data constituting the mini batch, and compares the SNNL value of the new data and the cumulative average SNNL value to determine whether to store the new data in the buffer.

Thereafter, the processor 180 of the artificial intelligence device 100 determines whether the buffer of the memory 170 is completely filled (S313).

The processor 180 may determine whether the storage space of the buffer of the memory 170 is completely filled with buffer data.

When it is determined that the buffer of the memory 170 is completely filled, the processor 180 of the artificial intelligence device 100 determines whether there exists buffer data with a cumulative average SNNL value greater than the SNNL value of the new data within the mini batch (S315).

The processor 180 may compare the cumulative average SNNL value of each buffer data included in the mini batch with the SNNL value of new data included in the mini batch.

In order to determine whether to store the new data in the buffer, the processor 180 may compare the cumulative average SNNL value of each buffer data with the SNNL value of the new data included in the mini batch.

When there is an existing single buffer data with a cumulative average SNNL value greater than the SNNL value of the new data, the processor 180 of the artificial intelligence device 100 exchanges the corresponding buffer data with new data and stores the exchanged new data in the buffer (S317).

In other words, when there is a single buffer data with a cumulative average SNNL value greater than the SNNL value of the new data, the processor 180 may replace the corresponding buffer data with the new data and store the replaced new data in the buffer.

In an embodiment, when there is a plurality of buffer data with a cumulative average SNNL value greater than the SNNL value of the new data, the processor 180 exchanges the buffer data with the largest SNNL value with new data and stores the exchanged new data in the buffer.

In another embodiment, when there is a plurality of buffer data with a cumulative average SNNL value greater than the SNNL value of the new data, the processor 180 exchanges one of the buffer data with the new data through random sampling, and stores the exchanged new data in the buffer.

FIG. 5 exemplarily illustrates that a new data set 510 is stored in the buffer instead of the buffer data set 530 previously stored in the buffer.

According to an embodiment of the invention, a part of the previous data is stored in the buffer and the previous data is utilized to train the product classification model together with new data. In this manner, the learning speed is improved and classification performance of both the previous data and new data may be improved.

When there is no existing buffer data with a cumulative average SNNL value greater than the SNNL value of the new data, the processor 180 of the artificial intelligence device 100 deletes the new data (S319).

The processor 180 may delete new normal product type data or new defective type data included in the mini batch and may not use them for training the product classification model.

Meanwhile, when the buffer of the memory 170 is not completely filled, the processor 180 of the artificial intelligence device 100 stores the new data set in the buffer (S321).

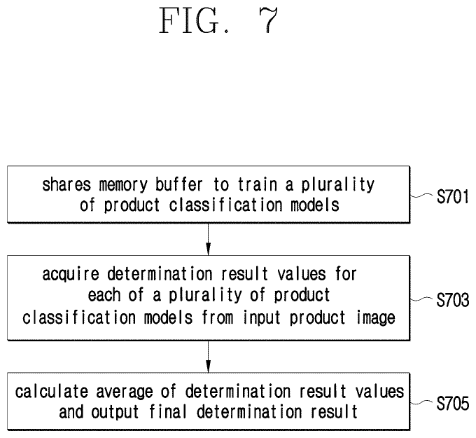

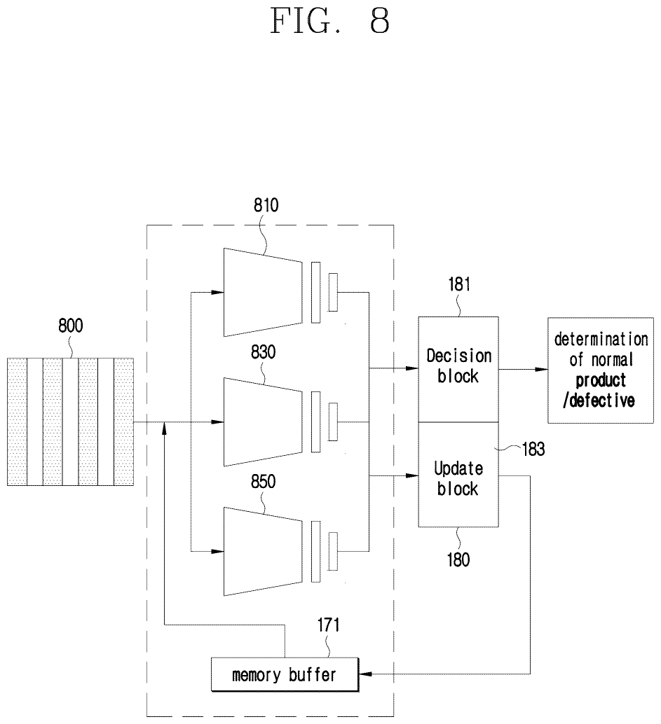

FIG. 7 is a diagram illustrating a method for operating an artificial intelligence device according to another embodiment of the invention, and FIG. 8 is a diagram structuring an embodiment in FIG. 7.

In particular, FIG. 7 relates to a continual learning method for a plurality of product classification models.

Referring to FIGS. 7 and 8, the processor 180 of the artificial intelligence (AI) device 100 shares one memory buffer 171 to train a plurality of product classification models 810, 830, and 850 through the learning processor 130 of AI device 100 (S701).

Each of the plurality of product classification models 810, 830, and 850 may be a model that outputs a normal product determination result from a product image.

Each of the plurality of product classification models 810, 830, and 850 may use the buffer data set stored in the memory buffer 171 for learning.

The processor 180 of the artificial intelligence device 100 acquires determination result values for each of the plurality of product classification models 810, 830, and 850 from the input product image 800 (S703).

The determination result value may be a confidence value for a normal product or one or more types of defects. The closer the confidence value is to 0, there is a lower likelihood of the product being the corresponding type, and the closer the confidence value is to 1, there is a higher likelihood of the product being the corresponding type.

The processor 180 of the artificial intelligence device 100 calculates the average of the determination result values and outputs the final determination result of the product whether the product is normal product or defective product (S705).

When the average of the determination result values is greater than or equal to a predetermined value, the processor 180 may determine the product to be a normal product. When the average of the determination result values is less than a predetermined value, the processor 180 may determine the product to be a defective product.

A determination block 181 included in the processor 180 may perform the steps S703 and S705 described above.

An update block 183 included in the processor 180 may update the data stored in the memory buffer 171.

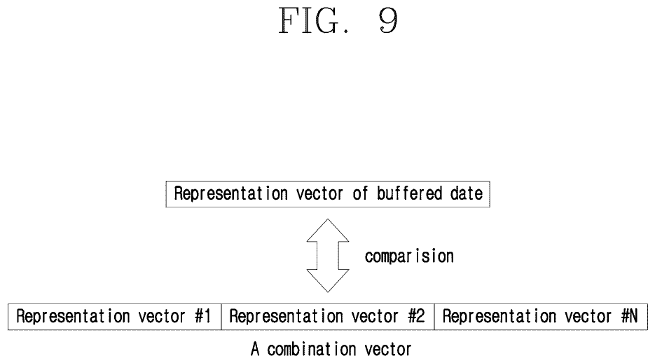

FIG. 9 is a diagram illustrating a process of updating a memory buffer based on representation vectors of each of a plurality of product classification models according to an embodiment of the invention.

In an embodiment, the update block 183 may generate a combination vector by combining representation vectors (#1 to #N) output from N product classification models, and compare the combination vector with the representation vector of the buffer data in the memory buffer 171.

Specifically, the update block 183 may compare the SNNL of the combination data corresponding to the combination vector and the SNNL of the buffer data. When the SNNL of the combined data is smaller than the SNNL of the buffer data, the update block 183 shown in FIG. 8 may exchange the buffer data with the combined data and store the combined data in the memory buffer 171.

A method for generating a combination vector of a plurality of representation vectors (#1 to #N) may include any one of a method for concatenating a plurality of representation vectors (#1 to #N), a method for randomly selecting an output of one model, and a method for calculating all outputs of each model and then selecting an optimal value among the outputs.

As such, according to an embodiment of the invention, it is possible to not only maintain the performance of the inspector but also improve the basic performance through ensemble by learning multiple deep learning models that share one memory buffer.

According to an embodiment of the invention, the above-described method may be realized as processor readable codes in a program recording medium. Examples of the processor readable medium may include ROM, RAM, CD-ROM, magnetic tape, floppy disk, optical data storage devices, and the like.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A vision inspection device comprising:
a memory including a buffer; and
a processor configured to:
i) acquire a plurality of divided images by dividing a captured product image into a plurality of pieces, and a new data set including new normal product type data and new defective type data corresponding to the plurality of divided images;
ii) sample at least one buffer data set among a plurality of buffer data sets stored in the buffer;
iii) generate a mini batch by combining the sampled buffer data set with the new data set; and
iv) determine whether to store the new data set in the buffer by using a soft nearest neighbor loss (SNNL) value of the new data set constituting the mini batch, and a cumulative average SNNL value of each of the buffer data sets constituting the mini batch.

2. The vision inspection device of claim 1, wherein when there is a single buffer data with a cumulative average SNNL value greater than the SNNL value of the new data set, the processor is configured to replace the corresponding buffer data set with the new data set and store the replaced new data set in the buffer.

3. The vision inspection device of claim 1, wherein when there is a plurality of buffer data with a cumulative average SNNL value greater than the SNNL value of the new data set, the processor is configured to exchange the buffer data with the largest SNNL value with new data set and store the exchanged new data in the buffer.

4. The vision inspection device of claim 1, wherein when there is a plurality of buffer data with a cumulative average SNNL value greater than the SNNL value of the new data set, the processor is configured to exchange one of the buffer data with new data set through random sampling and store the exchanged new data in the buffer.

5. The vision inspection device of claim 1, wherein when there is no buffer data set with a cumulative average SNNL value greater than the SNNL value of the new data set, the processor is configured to delete the new data set.

6. The vision inspection device of claim 1, wherein the processor is configured to calculate the SNNL value according to Equation 1 below.
$${l}_{sn} ( x , y , T ) = - \frac{1}{b} {\sum }_{i ∈ 1 … b} log ( \frac{{{{\sum }_{j ∈ 1 … b}}_{j \neq i}}_{{y}_{i} = {y}_{j}} {e}^{- \frac{{‖ {x}_{i} - {x}_{j} ‖}^{2}}{T}}}{{{{\sum }_{k ∈ 1 … b}}_{k \neq i}}^{e - \frac{{‖ {x}_{i} - {x}_{k} ‖}^{2}}{T}}} ) \qquad [ Equation 1 ]$$
wherein x denotes the representation vector of the input data, y denotes the class information, b denotes the batch, and T denotes the temperature of a hyperparameter.

7. The vision inspection device of claim 1, wherein when the new data set has a first label that matches the largest number of buffer data sets in the buffer, the processor is configured to generate the mini batch by sampling the buffer data set with the first label.

8. The vision inspection device of claim 1, wherein when the new data set has a second label that has previously matched the largest number of buffer data sets, the processor is configured to generate the minibatch by sampling the buffer data set with the second label.

9. The vision inspection device of claim 1, wherein when the new data set does not have a first label that currently matches the largest number of buffer data set and does not have a second label that previously matches the largest number of buffer data set, the processor is configured to generate the mini batch by sampling the buffer data set with the first label.

10. The vision inspection device of claim 1, wherein when the new data set does not have a first label that currently matches the largest number of buffer data set and does not have a second label that previously matches the largest number of buffer data set, the processor is configured to:
i) acquire a third label that currently matches the largest number of buffer data sets in the buffer;
ii) sample the buffer data set that matches the third label; and
iii) generate the mini batch.

11. The vision inspection device of claim 1, further comprising:
a learning processor configured to train one or more product classification models to determine whether a product is normal from the product image using updated data stored in the buffer.

12. The vision inspection device of claim 11, wherein the processor is further configured to:
a) share one memory buffer to train a plurality of product classification models through the learning processor;
b) acquire determination result values for each of the plurality of product classification models from the input product image; and
c) calculate the average of the determination result values and output the final determination result of the product whether the product is normal product or defective product.

13. The vision inspection device of claim 1, wherein the processor is configured to sample at least one buffer data set among the plurality of buffer data sets stored in the buffer based on a weight according to a preset reference.

14. A method for operating a vision inspection device including a buffer, the method comprising the steps of:
acquiring, by a processor, a plurality of divided images by dividing a captured product image into a plurality of pieces;
acquiring, by the processor, a new data set including new normal product type data and new defective type data corresponding to the plurality of divided images;
sampling, by the processor, at least one buffer data set among a plurality of buffer data sets stored in the buffer;
generating, by the processor, a mini batch by combining the sampled buffer data set with the new data set; and
determining, by the processor, whether to store the new data set in the buffer by using a soft nearest neighbor loss (SNNL) value of the new data set constituting the mini batch, and a cumulative average SNNL value of each of the buffer data sets constituting the mini batch.

15. The method of claim 14, wherein the step of sampling at least one buffer data set comprises the step of sampling at least one buffer data set among the plurality of buffer data sets stored in the buffer based on a weight according to a preset reference.

16. The method of claim 14, further comprising the steps of: when there is a single buffer data with a cumulative average SNNL value greater than the SNNL value of the new data set,
replacing, by the processor, the corresponding buffer data set with new data set; and
storing, by the processor, the replaced new data in the buffer.

17. The method of claim 14, further comprising the step of: when there is no buffer data with a cumulative average SNNL value greater than the SNNL value of the new data set,
deleting, by the processor, the new data set.

18. The method of claim 14, further comprising the step of:
training, by a learning processor, one or more product classification models to determine whether a product is normal from the product image using updated data stored in the buffer.

19. The method of claim 18, further comprising the steps of:
sharing, by the processor, one memory buffer to train a plurality of product classification models through the learning processor;
acquiring, by the processor, determination result values for each of the plurality of product classification models from the input product image; and
calculating, by the processor, the average of the determination result values and output the final determination result of the product whether the product is normal product or defective product.

20. A recording medium storing a computer-readable program for executing a method for operating a vision inspection device, wherein the method comprises the steps of:
acquiring a plurality of divided images by dividing a captured product image into a plurality of pieces;
acquiring a new data set including new normal product type data and new defective type data corresponding to the plurality of divided images;
sampling at least one buffer data set among a plurality of buffer data sets stored in the buffer based on a weight according to a preset reference;
generating a mini batch by combining the sampled buffer data set with the new data set; and
determining whether to store the new data set in the buffer by using a soft nearest neighbor loss (SNNL) value of the new data set constituting the mini batch, and a cumulative average SNNL value of each of the buffer data sets constituting the mini batch.
